(19) United States
(12) Patent Application Publication
(10) Pub. No.: US 2011/0301260 A1
(43) Pub. Date: Dec. 8, 2011

(54) HIGH-STRENGTH GLUE STICK FORMULATION

(75) Inventors: Joginder Kukreja, Brooklin (CA); Van R. Foster, Westerville, OH (US); Dana L. Conover, Dublin, OH (US)

(73) Assignee: ELMER'S PRODUCTS, INC., Westerville, OH (US)

(21) Appl. No.: 13/154,755

(22) Filed: Jun. 7, 2011

Related U.S. Application Data
(60) Provisional application No. 61/352,169, filed on Jun. 7, 2010.

(51) Int. Cl. C09J 189/00

(52) U.S. Cl. 523/122; 524/25

(57) ABSTRACT

A high-strength glue stick formulation that includes water; a defoamer; a bactericide; an oil; polyvinylpyrrolidone; a plurality of polyurethane dispersions; dipropylene glycol n-butyl ether; sodium stearate; casein; sodium hydroxide; and at least one adhesion promoter.

### DETAILED DESCRIPTION OF THE INVENTION

This patent application claims the benefit of U.S. Provisional Patent Application Ser. No. 61/352,169 filed on Jun. 07, 2010, and entitled “High Strength Stationery Glue Stick”, the disclosure of which is hereby incorporated by reference herein in its entirety and made part of the present U.S. utility patent application for all purposes.

### BACKGROUND OF THE INVENTION

The described invention relates in general to an adhesive formulation, and more specifically to a formulation for a high-strength glue stick that includes polyvinylpyrrolidone and a plurality of polyurethane dispersions.

Commercially available glue sticks typically include either polyvinylpyrrolidone (PVP) or modified polyvinyl alcohol (modified-PVOH) polymers. While generally effective for their intended purpose, such glue stick formulations usually only provide consistent adhesion to paper and wood substrates, which limits their overall usefulness. Waterborne acrylic polymers are useful for a variety of adhesives because such polymers typically adhere to a much greater variety of surfaces than polyvinyl acetate (PVAc) and PVP-based products. However, mixing and processing waterborne polymers is often difficult because latex emulsions may become destabilized when exposed to high temperatures for sustained periods of time. Production of glue sticks typically requires high temperatures for dissolving some of the other materials commonly included in glue sticks. Therefore, there is an ongoing need for a glue stick product that is useful for providing consistent adhesion to a variety of substrates, such as wood, metal and plastic; that maintains a high degree of lubricity when applying the glue from the stick; and that can be formulated in a relatively easy manner.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a high-strength glue stick formulation is provided. This formulation includes polyvinylpyrrolidone; a plurality of polyurethane dispersions; casein; and at least one adhesion promoter. The plurality of polyurethane dispersions may include Sancure 2710; Sancure 20025F; and Sancure 12929.

In accordance with another aspect of the present invention, a high-strength glue stick formulation is also provided. This formulation includes water; a defoamer; a bactericide; an oil; polyvinylpyrrolidone; a plurality of polyurethane dispersions; dipropylene glycol n-butyl ether; sodium stearate; casein; sodium hydroxide; and at least one adhesion promoter. The plurality of polyurethane dispersions may include Sancure 2710; Sancure 20025F; and Sancure 12929.

In yet another aspect of this invention, a high-strength glue stick formulation is also provided. This formulation includes water; a defoamer; eythyl paraben; glycerin; polyvinylpyrrolidone; first, second, and third polyurethane dispersions; dipropylene glycol n-butyl ether; sodium stearate; casein; sodium hydroxide; and at least one adhesion promoter. The plurality of polyurethane dispersions may include Sancure 2710; Sancure 20025F; and Sancure 12929.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the associated descriptions are to be regarded as illustrative and not restrictive in nature.

### DETAILED DESCRIPTION OF THE INVENTION

Exemplary embodiments of the present invention are now described with reference to the example. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

An exemplary embodiment of the high-strength glue stick formulation of the present invention includes a PVP polymer such as K-30 (International Specialty Products; Wayne, N.J.) the polyurethane dispersions Sancure 2710; Sancure 20025F; and Sancure 12929 (The Lubrizol Corporation; Wickliffe, Ohio), as well as casein, and a silane adhesion promoter such as Silquest Wetlink 78 (GE Advanced Materials; Pittsfield, Massachusetts) for improving adhesion to surfaces such as metal and glass. The combination of multiple Sancure polymers and casein provide improved adhesive strength to the formula. This high-strength glue stick formulation may also include a defoamer such as BYK-045 (BYK Additives and Instruments; Wesel, Germany), which is a silicone defoamer for aqueous systems that includes an emulsion of foam destroying polysiloxanes, hydrophobic solids and emulsifiers. The formulation may also include a bactericide, such as ethyl paraben and an oil such as glyercin. Other possible ingredients include dipropylene glycol n-butyl ether (DPnB), sodium stearate, and sodium hydroxide.

Having generally described this invention, a further understanding can be obtained by reference to the specific example detailed below, which is provided for purposes of illustration only and is not intended to be all inclusive or limiting unless otherwise specified. As indicated below, percent by weight values for each ingredient are provided in this example.

### EXAMPLE

High-Strength Glue Stick Formulation

| RAW MATERIAL | % by WEIGHT | DESCRIPTION |
|---|---|---|
| Water | 8.1 | — |
| BYK 045 | 0.20 | defoamer |
| Ethyl Paraben | 0.10 | bactericide |
| Glycerin | 4.0 | oil |
| K-30 | 12.2 | PVP polymer |
| Sancure 2710 | 20.30 | polyurethane dispersion |
| Sancure 20025F | 20.30 | polyurethane dispersion |
| Sancure 12929 | 20.30 | polyurethane dispersion |
| DPnB | 2.0 | dipropylene glycol n-butyl ether |
| Sodium Stearate | 4.5 | — |
| 7.4% NaOH solution | 1.60 | — |
| 25% Casein Solution | 6.30 | — |
| Silquest Wetlink 78 | 0.10 | adhesion promoter |
| | 100.00 | |

With reference to the example given above, the following stepwise process is used to prepare a high-strength glue stick using the listed ingredients: (i) using a variable speed mixer fitted with a shear mixing blade, prepare a PVP solution; add deionized water to a container and start the mixer at medium speed; add BYK-045, ethyl paraben, glycerin and PVP K-30 to the container; mix the material until the K-30 is completely dispersed; (ii) using a closed mixing vessel capable of heating/cooling and having vacuum capability, add the Sancure 2710, Sancure 200025F, and Sancure 12929 and mix for 5-10 minutes; (iii) slowly add the PVP premix of step (i) into the closed container; continue mixing for 10-15 minutes; (iv) add DPnB and mix for 5-10 minutes; (v) add sodium stearate slowly while mixing and heat the mixing vessel to 65°-75° C.; mix 5-10 minutes; (vi) add the 7.4% sodium hydroxide solution and mix until it becomes a homogeneous, even solution; (vii) prepare separately a 25% casein solution that consists of 25% casein, 5% of a 37.4% sodium hydroxide solution and 70% deionized water; (viii) add the casein solution to the mixer and continue mixing for 5-10 minutes; (ix) add the silane adhesion promoter and mix for 5 minutes; (x) vacuum the mixture at a slow speed for 10-15 minutes; and (xi) using a pressure plate, extrude the finished product into the desired size glue stick containers.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A glue stick formulation, comprising:
(a) polyvinylpyrrolidone;
(b) a plurality of polyurethane dispersions;
(c) casein; and
(d) at least one adhesion promoter.

2) The formulation of claim 1, further comprising water.

3) The formulation of claim 1, further comprising a defoamer.

4) The formulation of claim 1, further comprising a bactericide.

5) The formulation of claim 1, further comprising an oil.

6) The formulation of claim 1, further comprising sodium stearate.

7) The formulation of claim 1, further comprising sodium hydroxide.

8) A glue stick formulation, comprising:
(a) water;
(b) a defoamer;
(c) a bactericide;
(d) an oil;
(e) polyvinylpyrrolidone;
(f) a plurality of polyurethane dispersions;
(g) dipropylene glycol n-butyl ether;
(h) sodium stearate;
(i) casein;
(j) sodium hydroxide; and
(k) at least one adhesion promoter.

9) The formulation of claim 8, wherein the defoamer is a silicone defoamer for aqueous systems.

10) The formulation of claim 8, wherein the bactericide is ethyl paraben.

11) The formulation of claim 8, wherein the oil is glycerin.

12) The formulation of claim 8, wherein the plurality of polyurethane dispersions further includes SANCURE 2710; SANCURE 20025F; and SANCURE 12929.

13) The formulation of claim 8, wherein the at least one adhesion promoter is SILQUEST WETLINK 78 Silane.

14) A glue stick formulation, comprising:
(a) water;
(b) a defoamer;
(c) eythyl paraben;
(d) glycerin;
(e) polyvinylpyrrolidone;
(f) first, second, and third polyurethane dispersions;
(g) dipropylene glycol n-butyl ether;
(h) sodium stearate;
(i) casein;
(j) sodium hydroxide; and
(k) at least one adhesion promoter.

15) The formulation of claim 14, wherein the defoamer is BYK-045.

16) The formulation of claim 14, wherein the polyvinylpyrrolidone is K-30.

17) The formulation of claim 14, wherein the first polyurethane dispersion is SANCURE 2710.

18) The formulation of claim 14, wherein the second polyurethane dispersion is SANCURE 20025F.

19) The formulation of claim 14, wherein the third polyurethane dispersion is SANCURE 12929.

20) The formulation of claim 14, wherein the at least one adhesion promoter is SILQUEST WETLINK 78 Silane.
